(19) United States
(12) Patent Application Publication
(10) Pub. No.: US 2025/0214465 A1
(43) Pub. Date: Jul. 3, 2025

(54) CHARGER

(71) Applicant: TOYOTA JIDOSHA KABUSHIKI KAISHA, Toyota-shi (JP)

(72) Inventor: Shoya OKOCHI, Toyota-shi (JP)

(73) Assignee: TOYOTA JIDOSHA KABUSHIKI KAISHA, Toyota-shi (JP)

(21) Appl. No.: 18/904,637

(22) Filed: Oct. 2, 2024

(30) Foreign Application Priority Data
Dec. 28, 2023 (JP) 2023-222663

(51) Int. Cl. B60L 53/20

(52) U.S. Cl. CPC B60L 53/20; B60L 2210/14; B60L 2210/30

(57) ABSTRACT

A charger mounted on an electrified vehicle includes a power converter that converts input electric power supplied from an external charging power source into charging power supplied to a battery mounted on electrified vehicle, and a control device that controls an operation of the power converter, wherein the control device decides a maximum value of the input electric power supplied from the charging power source to the power converter, and intermittently operates the power converter based on the decided maximum value of the input electric power and the rated power of the power converter.

### CROSS-REFERENCE TO RELATED APPLICATION

This application claims priority to Japanese Patent Application No. 2023-222663 filed on Dec. 28, 2023, incorporated herein by reference in its entirety.

### BACKGROUND

### 1. Technical Field

The technology disclosed in the present specification relates to a charger installed in an electrified vehicle.

### 2. Description of Related Art

Japanese Unexamined Patent Application Publication No. 2017-130997 (JP 2017-130997 A) discloses intermittent operation of a power converter, as an electric power adjustment method that emphasizes loss reduction in a low output region. In the intermittent operation, transmitted electric power is adjusted on average by providing an electric power transmission pause period. As a result, stable operation and loss reduction in the low output region of the power converter are realized.

### SUMMARY

Generally, a charger installed in an electrified vehicle is designed such that power-conversion efficiency thereof is maximized at a rated power (i.e., maximum-input electric power). However, the rated power is not necessarily input to the charger, due to external factors such as, for example, specifications of a charging cable connected to the vehicle, specifications of the charging power source used, and so forth. For example, when input electric power that is input to the charger is small with respect to the rated power of the charger, the power conversion efficiency of the charger can be expected to be significantly reduced. In the present specification, technology that is capable of enhancing electric power conversion efficiency in a charger is provided.

The present specification discloses a charger installed in an electrified vehicle. In a first aspect, the charger includes
a power converter that converts input electric power supplied from an external charging power source into charging electric power supplied to a battery installed in the electrified vehicle, and
a control device that controls an operation of the power converter, wherein the control device
decides a maximum value of the input electric power supplied from the charging power source to the power converter, and
intermittently operates the power converter, based on the maximum value of the input electric power that is decided, and rated power of the power converter.

According to the above configuration, the charger intermittently operates the power converter based on the maximum value of the input electric power and the rated power of the power converter. In particular, when the maximum value of the input electric power is smaller than the rated power of the power converter, the power converter can be intermittently operated. Accordingly, even in a situation in which the rated power is not necessarily input to the charger, electric power conversion efficiency in the charger can be increased.

In a second aspect, according to the first aspect, the control device may decide the maximum value of the input electric power by using an input voltage input from the charging power source to the power converter and a maximum value of an input current input from the charging power source to the power converter.

A third aspect according to the second aspect may further include a voltage sensor that detects the input voltage, and
the control device may acquire the input voltage from the voltage sensor, and also acquire
the maximum value of the input current through communication with a side of the charging power source.

According to the above configuration, the maximum value of the input electric power can be appropriately decided by using the input voltage acquired from the voltage sensor and the maximum value of the input current acquired by communication with the charging power source side.

In a fourth aspect, according to the third aspect,
the maximum value of the input current may be a rated current of a charging cable of the charging power source connected to the electrified vehicle, and
the control device may communicate with a charging circuit interrupting device (CCID) provided to the charging cable, to acquire the rated current of the charging cable.
   According to the above-described configuration, the control device can appropriately decide the maximum value of the input electric power by using the rated current of the charging cable acquired by communication with the CCID.

In a fifth aspect, according to any one of the first through fourth aspects, the control device may intermittently operate the power converter such that power conversion efficiency of the power converter exceeds a predetermined reference value when the maximum value of the input electric power is smaller than a predetermined threshold value with respect to the rated power of the power converter.

This enables the electric power conversion efficiency in the charger to be increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an electrified vehicle and power system; and

FIG. 2 is a flowchart of a process executed by the charger.

### DETAILED DESCRIPTION OF EMBODIMENTS

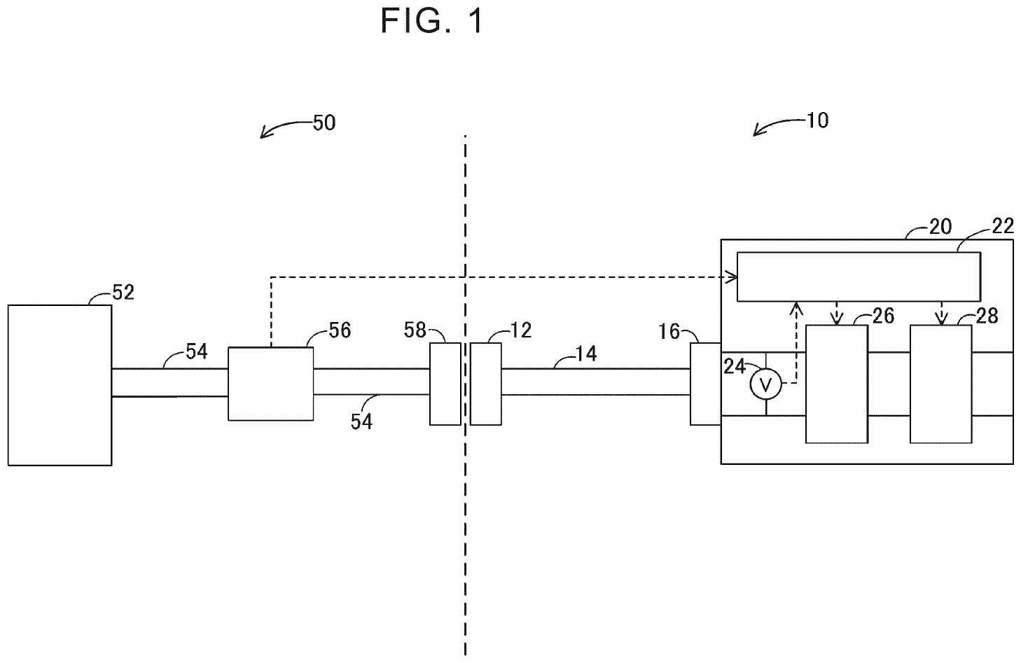

FIG. 1 is a schematic diagram of an electrified vehicle 10 and power system 50. A charging power source 52 and a charging cable 54 are provided on the power system 50 side. The charging power source 52 outputs AC power. One end of the charging cable 54 is connected to the charging power source 52. The other end of the charging cable 54 is provided with a connector 58 for connecting to an electrified vehicle 10 (specifically, electrified vehicle 10 inlet 12). In addition, the charging cable 54 is provided with a Charge Circuit Interrupt Device (CCID) 56. CCID 56 has control circuitry for controlling the charge of electrified vehicle 10.

Electrified vehicle 10 includes a battery (not shown) and a driving motor. Electrified vehicle 10 is, for example, battery electric vehicle, plug-in hybrid electric vehicle or the like. Electrified vehicle 10 includes a charger 20.

The battery of electrified vehicle 10 is charged by electric power inputted from the charging power source 52 via the charging cable 54. As shown in FIG. 1, the inlet 12 is connected to the charger 20 via the power transmission path 14 and the connector 16. When the connector 58 of the charging cable 54 is connected to the inlet 12 of electrified vehicle 10, power is inputted to the charger 20 via the inlet 12, the power transmission path 14, and the connector 16. The charger 20 converts the input electric power and supplies the converted power to the battery.

The charger 20 includes a control device 22, a voltage sensor 24, an AC/DC converter 26, and a DC/DC converter 28. The voltage sensor 24 detects an input voltage from the power system 50. AC/DC converters 26 convert AC power from the power system 50 into DC power. DC/DC converter 28 boosts the DC power outputted from AC/DC converter 26. That is, AC/DC converter 26 and DC/DC converter 28 are power converters that convert the incoming power supplied from the external charging power source 52 into the charging power supplied to the battery mounted on electrified vehicle 10. Circuitry configurations of AC/DC converter 26 and DC/DC converter 28 are well known, and thus detailed explanation thereof is omitted.

The control device 22 is configured to be able to communicate with AC/DC converter 26 and DC/DC converter 28, and controls the operation of AC/DC converter 26 and DC/DC converter 28. Specifically, for example, the control device 22 controls AC/DC converter 26 and DC/DC converter 28 by supplying PWM to AC/DC converter 26 and DC/DC converter 28.

In addition, the control device 22 is configured to be capable of communicating with the voltage sensor 24, and acquires an input voltage from the voltage sensor 24. Further, the control device 22 is configured to be able to communicate with a CCID 56 provided in the charging cable 54 of the power system 50, and is configured to acquire the rated current of the charging cable 54 from the charging cable 54 by communication. As will be described in greater detail below, the control device 22 decides the maxima of the input electric power supplied to DC/DC converters 28 from these input voltages and the rated current of the charging cable 54. Then, the control device 22 intermittently operates DC/DC converter 28 based on the decided maximum-input electric power and the rated power of DC/DC converter 28.

Here, “intermittent operation” means an operation mode in which a pause time for pausing power transmission is provided, and is also referred to as a burst mode. In the intermittent operation of DC/DC converter 28 of the present embodiment, the operation time for switching the switching elements of DC/DC converter 28 and the pause time for stopping the switching of the switching elements are repeated. The intermittent operation is an operation mode in which conversion efficiency is emphasized, and is particularly used to realize loss reduction in a low-output region.

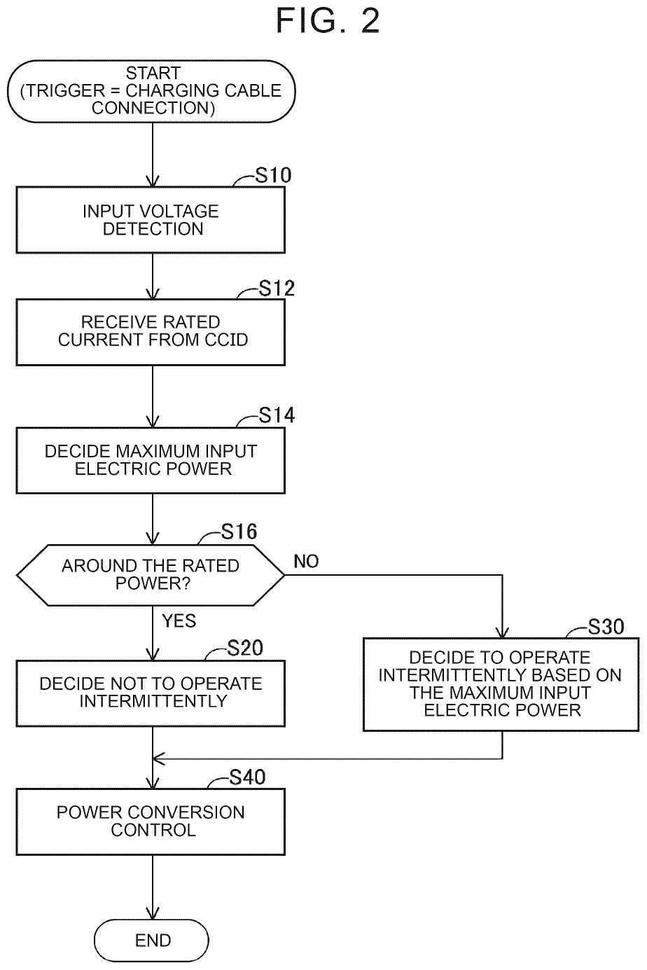

Next, a process executed by the control device 22 of the charger 20 will be described with reference to FIG. 2. The process of FIG. 2 is started as a trigger that the connector 58 of the charging cable 54 is connected to the inlet 12.

In S10, the control device 22 detects the input-voltage. Specifically, when the connector 58 of the charging cable 54 is connected to the inlet 12, power is input from the charging power source 52 to the charger 20, and therefore, a voltage is input to the charger 20. The voltage sensor 24 detects an input voltage supplied to the charger 20 and outputs the input voltage to the control device 22. Thus, the control device 22 detects the input voltage.

In S12, the control device 22 acquires (i.e., receives) the rated current of the charging cable 54 from CCID 56 by communication. Specifically, the charging cable 54 is provided with a control pilot signal line. The control device 22 receives the rated current of the charging cable 54 from CCID 56 via the control pilot-signal line of the charging cable 54. Note that the order of S10 process and S12 process is exemplary, and S12 process may be executed prior to S10 process.

The control device 22 decides the maxima of the incoming power in S14. Specifically, the control device 22 decides the maximum input electric power using the input voltage detected by S10 and the rated current received by S12. More specifically, the control device 22 decides the maximum value of the input electric power by calculating the product of the input voltage and the rated current.

The control device 22 determines in S16 whether the decided peak power is near the rated power of DC/DC converters 28. Specifically, the control device 22 determines whether or not the maximum value of the input electric power is smaller than a predetermined threshold value with respect to the rated power. When the maximum value of the input electric power is smaller than the predetermined threshold value with respect to the rated power (that is, when the maximum value of the input electric power is not near the rated power), the control device 22 determines that the input electric power is NO in S16 and proceeds to S30. On the other hand, when the maximum value of the input electric power is not smaller than the predetermined threshold value with respect to the rated power (that is, when the maximum value of the input electric power is near the rated power), the control device 22 determines that the input electric power is YES in S16 and proceeds to S20.

Here, the reason why S16 process is executed from the above-described S10 will be described. Generally, the charger 20 (in particular, DC/DC converter 28) is designed to maximize the power-conversion efficiency when the rated power is inputted to the charger 20. However, the rated power of the charger 20 is not necessarily input to the charger 20 due to external factors. The external factor is, for example, the specification of the charging cable 54 connected to electrified vehicle 10 (for example, the rated current of the charging cable 54), the specification of the charging power source 52 to be used (for example, the output-voltage of the charging power source 52), and the like. Such external factors may cause the rated current of the charging cable 54 to be less than the current required to input the rated power of the charger 20 to the charger 20. In this case, the input electric power input to the charger 20 is smaller than the rated power of the charger 20. In such a case, the power conversion efficiency of the charger 20 decreases as compared with a case where the rated power is input to the charger 20.

Under such circumstances, the control device 22 of the present embodiment executes S16 process from S10. The control device 22 executes S16 process from S10 to decide whether or not to perform intermittent operation based on the inputted power inputted to the charger 20 and the rated power of the charger 20. In addition, the control device 22 decides the pause time in the case of intermittent operation. That is, by executing S16 process from S10, it is possible to increase the power-conversion-efficiency of the charger 20.

The description of the flowchart is returned again. The control device 22 decides not to operate intermittently in S20. That is, in this case, a pause time is not provided in the power conversion control described later.

The control device 22 decides to operate intermittently based on the maxima of the incoming power in S30. Specifically, the control device 22 decides the pause time based on the maximum value of the input electric power and the rated power of the charger 20. The pause time is set to a time at which the power-conversion-efficiency of DC/DC converters 28 exceeds a predetermined reference value.

The control device 22 starts power converting control in S40. Specifically, the control device 22 starts controlling the operations of AC/DC converter 26 and DC/DC converter 28 (for example, starts supplying PWM). In particular, the control device 22 intermittently operates S20 passing S40 DC/DC converter 28, and does not intermittently operate DC/DC converter 28 in S40 in S30 passing through. The pause time of the intermittent operation is set to a time such that the power-conversion-efficiency of DC/DC converters 28 exceeds a predetermined reference value.

In this way, the control device 22 of the present embodiment intermittently operates DC/DC converters 28 when the maximum value of the inputted power is smaller than a predetermined threshold value with respect to the rated power. For this reason, even in a situation where power smaller than the rated power is inputted to DC/DC converter 28, it is possible to improve the power-conversion-efficiency of DC/DC converter 28.

Although the specific examples disclosed by the present disclosure have been described in detail above, these are merely examples and do not limit the scope of claims. The techniques described in the claims include various modifications and alternations of the specific examples illustrated above.

### Modified Example 1

In the above embodiment, the control device 22, the largest value of the input electric power was decided (S14 from S10 of FIG. 2). Alternatively, the control device 22 may not decide the maximum value of the input electric power by itself. For example, the control device 22 may acquire the maximum value of the input electric power from the outside by communication. In this case, the charger 20 may not include the voltage sensor 24.

### Modified Example 2

In S12 of FIG. 2, the control device 22 may receive an allowable current that may vary depending on, for example, the use state of the charging cable 54, instead of the rated current of the charging cable 54. Further, the transmitting subject of the rated current of the charging cable 54 may not be a CCID 56, and may be, for example, a charging power source 52.

The technical elements described in the present specification or drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A charger installed in an electrified vehicle, the charger comprising:
a power converter that converts input electric power supplied from an external charging power source into charging electric power supplied to a battery installed in the electrified vehicle; and
a control device that controls an operation of the power converter, wherein the control device
decides a maximum value of the input electric power supplied from the charging power source to the power converter, and
intermittently operates the power converter, based on the maximum value of the input electric power that is decided, and rated power of the power converter.

2. The charger according to claim 1, wherein the control device decides the maximum value of the input electric power by using an input voltage input from the charging power source to the power converter and a maximum value of an input current input from the charging power source to the power converter.

3. The charger according to claim 2, further comprising a voltage sensor that detects the input voltage, wherein the control device acquires the input voltage from the voltage sensor, and also acquires the maximum value of the input current through communication with a side of the charging power source.

4. The charger according to claim 3, wherein:
the maximum value of the input current is a rated current of a charging cable of the charging power source connected to the electrified vehicle; and
the control device communicates with a charging circuit interrupting device provided to the charging cable, to acquire the rated current of the charging cable.

5. The charger according to claim 1, wherein the control device intermittently operates the power converter such that power conversion efficiency of the power converter exceeds a predetermined reference value when the maximum value of the input electric power is smaller than a predetermined threshold value with respect to the rated power of the power converter.
